(19) United States
(12) Patent Application Publication
(10) Pub. No.: US 2004/0048195 A1
(43) Pub. Date: Mar. 11, 2004

(54) Heat-sensitive lithographic printing plate precursor

(75) Inventors: Geert Deroover, Lier (BE); Marc Van Damme, Bonheiden (BE); Joan Vermeersch, Deinze (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: AGFA-GEVAERT, Mortsel (BE)

(21) Appl. No.: 10/654,508

(22) Filed: Sep. 3, 2003

Related U.S. Application Data
(60) Provisional application No. 60/413,098, filed on Sep. 24, 2002.

(30) Foreign Application Priority Data
Sep. 4, 2002 (EP) 02102303.1

(51) Int. Cl. B41C 1/10; G03C 1/77

(52) U.S. Cl. 430/271.1; 430/270.1; 430/270.18; 430/281.1; 430/905; 430/944; 430/919; 430/920; 101/467

(57) ABSTRACT

A heat-sensitive lithographic printing plate precursor is disclosed which comprises a hydrophilic support and a coating provided thereon, wherein the coating comprises an infrared light absorbing cyanine dye, the dye containing a bridged methine chain and from three to five groups which are anionic or which become anionic in an aqueous alkaline solution having a pH of at least 9. Such dyes provide high sensitivity and low dye stain after processing.

This application claims the benefit of U.S. Provisional Patent Application No. 60/413,098 filed Sep. 24, 2002, which is incorporated by reference.

### DESCRIPTION

1. Field of the Invention

The present invention relates to a heat-sensitive lithographic printing plate precursor that requires aqueous alkaline processing.

2. Background of the Invention

Lithographic printing typically involves the use of a so-called printing master such as a printing plate which is mounted on a cylinder of a rotary printing press. The master carries a lithographic image on its surface and a print is obtained by applying ink to said image and then transferring the ink from the master onto a receiver material, which is typically paper. In conventional lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. In so-called driographic printing, the lithographic image consists of ink-accepting and ink-abhesive (ink-repelling) areas and during driographic printing, only ink is supplied to the master.

Printing masters are generally obtained by the so-called computer-to-film method wherein various pre-press steps such as typeface selection, scanning, color separation, screening, trapping, layout and imposition are accomplished digitally and each color selection is transferred to graphic arts film using an image-setter. After processing, the film can be used as a mask for the exposure of an imaging material called plate precursor and after plate processing, a printing plate is obtained which can be used as a master.

A typical photosensitive printing plate precursor for computer-to-film methods comprises a hydrophilic support and an image-recording layer which includes UV-sensitive compositions. Upon image-wise exposure of a negative-working plate, typically by means of a film mask in a UV contact frame, the exposed image areas become insoluble and the unexposed areas remain soluble in an aqueous alkaline developer. The plate is then processed with the developer to remove the diazonium salt or diazo resin in the unexposed areas. So the exposed areas define the image areas (printing areas) of the printing master, and such printing plate precursors are therefore called ‘negative-working’. Also positive-working materials, wherein the exposed areas define the non-printing areas, are known, e.g. plates having a novolac/naphtoquinone-diazide coating which dissolves in the developer only at exposed areas.

In addition to the above photosensitive materials, also heat-sensitive printing plate precursors have become very popular. Such thermal materials offer the advantage of daylight-stability and are especially used in the so-called computer-to-plate method wherein the plate precursor is directly exposed, i.e. without the use of a film mask. Usually, the material is image-wise exposed to heat or to infrared laser light and the generated heat triggers a (physico-)chemical process, such as ablation, polymerization, insolubilization by cross-linking of a polymer or by particle coagulation of a thermoplastic polymer latex, and solubilization by the destruction of intermolecular interactions.

The coating of a typical heat-sensitive lithographic printing plate precursor which requires alkaline processing, contains an alkali-soluble binder and an infrared light absorbing compound, which converts infrared light into heat. The light-to-heat converting compound is typically an organic dye, often a cyanine dye, which acts as a dissolution inhibitor on the binder, i.e. it increases the resistance of the coating towards the alkaline developer and thereby reduces the sensitivity of the coating. As a result, a high light power or a longer exposure time is required during the image-wise exposure. WO97/39894 and EP-A 823327 disclose examples of such inhibiting dyes.

EP-A 978376 discloses that infrared cyanine dyes having a betaine structure do not reduce the solubility of the coating in the developer. These dyes, however, are not readily soluble in an alkaline developer and tend to cause dye stain at non-image areas of the printing plate.

### SUMMARY OF THE INVENTION

It is an aspect of the present invention to provide a thermal lithographic printing plate precursor having a high sensitivity towards infrared light and which does not show dye stain in the non-image areas after exposure and processing. This object is realized by the material of claim 1. Preferred embodiments are defined in the dependent claims.

The cyanine dyes which are defined in claim 1 comprise a bridged methine chain and three, four or five solubilizing groups. Dyes having less than three solubilizing groups do not provide the combined advantage of high speed and low stain, whereas dyes having more than five solubilizing groups tend to precipitate by crystallization from the coating solution or from the coated layer during the drying step.

### DETAILED DESCRIPTION OF THE INVENTION

The heat-sensitive lithographic printing plate precursor of the present invention contains a hydrophilic support and a coating comprising an oleophilic layer provided thereon. Besides the oleophilic layer, the coating may also comprise one or more additional layer(s) of which examples are discussed below.

The coating contains, in the oleophilic layer and/or in any of said additional layers, an infrared light absorbing compound according to the following formula I:

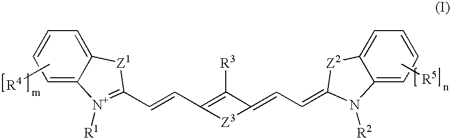

wherein

m and n each independently represent an integer from 0 to 4;

Z¹ and Z² each independently represent one or two non-metallic atoms, which may be substituted, necessary to complete a 5- or 6-membered heterocyclic ring;

Z³ represents two or three non-metallic atoms, which may be substituted, necessary to complete a 5- or 6-membered heterocyclic or carbocyclic ring;

each R¹, R², R⁴ and R⁵ independently represent an optionally substituted alkyl, alkenyl, aryl or aralkyl group, or a group selected from -G¹, -L₁-G¹, —CN, a halogen, —NO₂, —ORₐ, —CO—Rₐ, —CO—O—Rₐ, —O—CO—R_{d}, —CO—NR_{d}Rₑ, —NR_{d}Rₑ, —NR_{d}—CO—Rₑ, —NR_{d}—CO—O—Rₐ, —NR_{d}—CO—NRₑR_{f}, —SR_{d}, —SO—Rₐ, —SO₂—Rₐ, —SO₂—O—Rₐ and —SO₂—NRₐR_{b}; is or wherein two adjacent R⁴ and R⁵ groups together form an optionally substituted 5- or 6 membered ring which is fused to the ring formed by Z¹ or Z²;

R³ represents a hydrogen or a halogen atom, -L²-G², an alkyl group, an alkenyl group, an aralkyl group, an aryl group, a thioalkyl group or a thioaryl group, each of said groups being optionally substituted;

with

L¹ and L² being a divalent linking group, e.g. arylene or alkylene;

Rₐ, R_{b} and R_{c} being an optionally substituted alkyl, alkenyl, aryl or aralkyl group;

R^{d}, R^{e}, and R^{f} being hydrogen or an optionally substituted alkyl, alkenyl, aryl or aralkyl group.

In the above formula, G¹ and G² are solubilizing groups, i.e. groups which are anionic or which become anionic in an aqueous alkaline solution having a pH of at least 9, preferably at least 12. The total number of solubilizing groups G¹ and G² is equal to three, four or five. Suitable examples of such solubilizing groups are —COOH, —OH, —PO₃H₂, —O—PO₃H₂, —SO₃H, —O—SO₃H, —SO₂—NH₂, —SO₂—NH—R, —SO₂—NH—CO—R, or the salts of any of these groups, e.g. alkali or earth alkali metal salts or mono-, di- or trialkylammonium salts, with R being an optionally substituted alkyl, alkenyl, aryl or aralkyl group. The most preferred embodiments are —COOH, —SO₃H, and —OH. The concentration of the IR absorbing compound in the coating is typically between 0.25 and 10.0 wt. %, more preferably between 0.5 and 7.5 wt. %, relative to all non-volatile ingredients of the coating.

Suitable subclasses of the above dyes are represented by the following formulae:

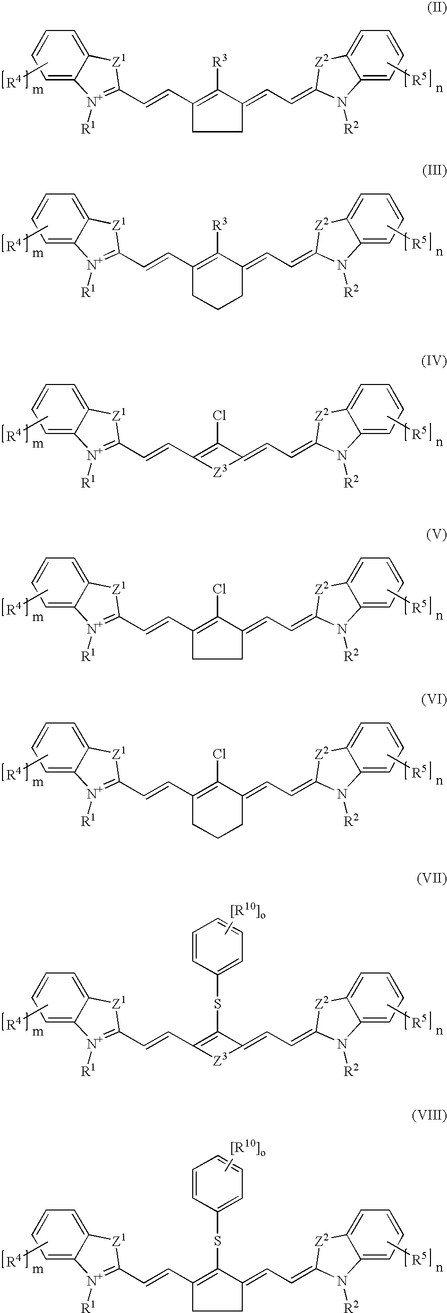

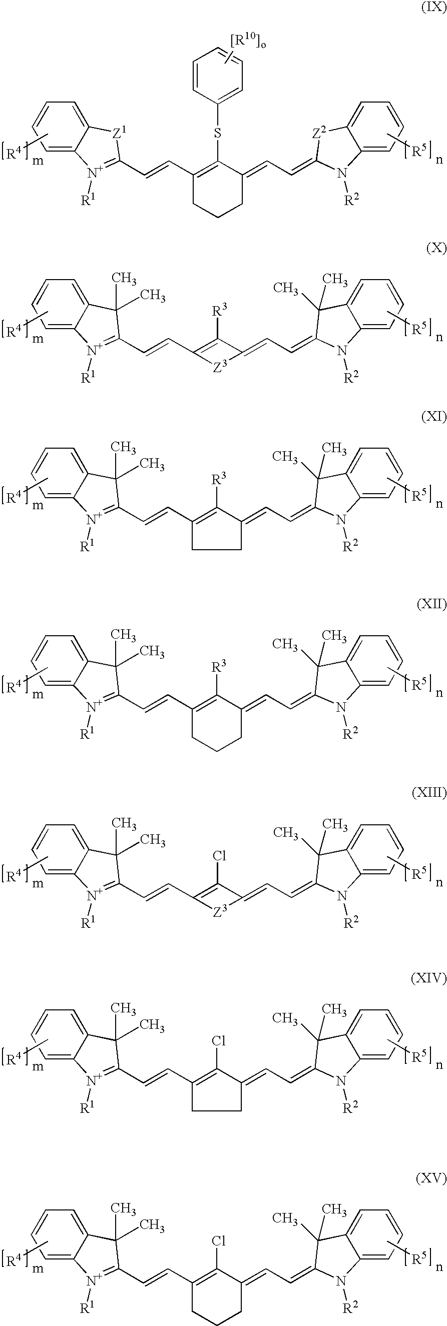

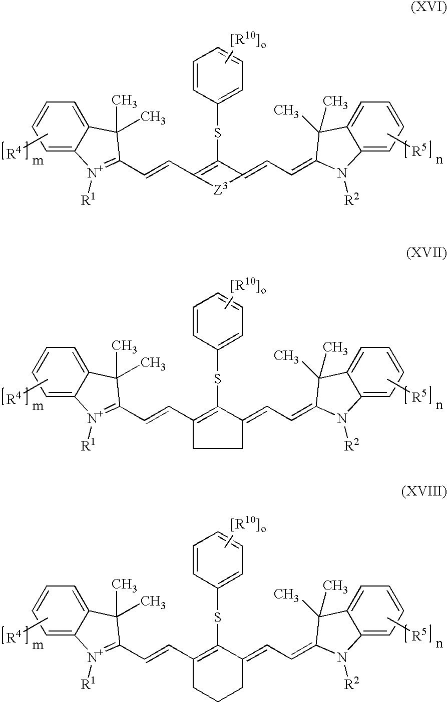

In the above formula II-XVIII, m, n, R¹, R², R³, R⁴, R⁵, Z¹, Z² and Z³ have the same meaning as in formula I above. Integer o has a value between 0 and 5. R¹⁰ represents a group as defined for R⁴ and R⁵.

Additional preferred subclasses of the dyes of our invention are represented by embodiments of any of the above formula I to XVIII wherein

R comprises at least one solubilizing group; or

R¹, R², R³, R⁴ and R⁵ each comprise one solubilizing group; or

the dye comprises three solubilizing groups, of which one is comprised in each of R¹, R² and R³;

the dye comprises three solubilizing groups, of which one is comprises in each of R³, R⁴ and R⁵; or

the dye comprises four solubilizing groups, of which one is comprised in each of R¹, R², R⁴ and R⁵.

Other suitable subclasses are represented by formulae wherein two adjacent R⁴ and/or R⁵ groups together form a phenyl group, which may be substituted, which is fused to the ring formed by Z¹ and Z² respectively. So any of the above formula I to XVIII wherein such fused phenyl group is present also represent dyes that are suitable for a precursor of the present invention. Two preferred embodiments of such dyes are represented by formula XIX and XX:

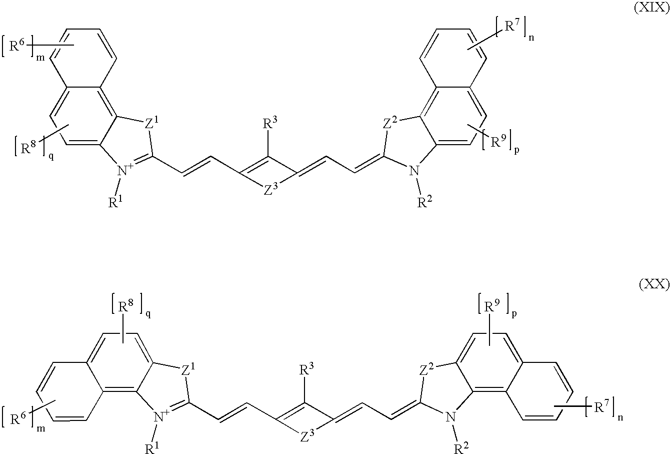

wherein m, n, R¹, R², R³, Z¹, Z² and Z³ have the same meaning as in formula I above; p and q are independently 0, 1 or 2 and each R⁶ to R⁹ independently represents a group as defined for R¹ and R² above. The above two configurations of fused phenyl groups are derivatives of formula I above. Similar derivatives can be constructed from any of the formula II to XVIII and such subclasses also are part of the present invention.

Specific examples of the above formulae include the following dyes:

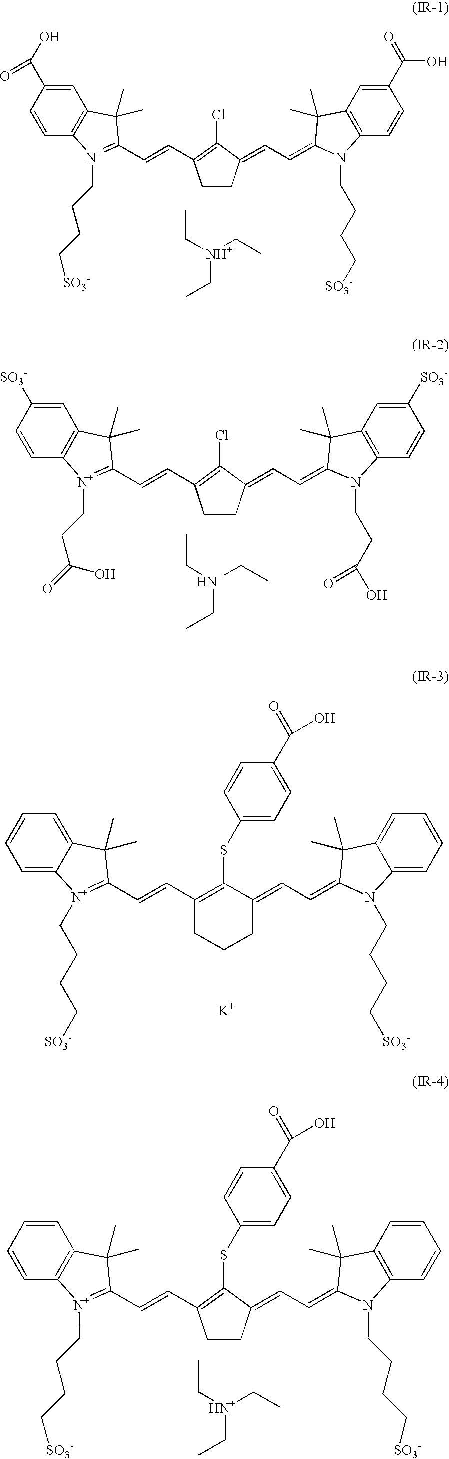

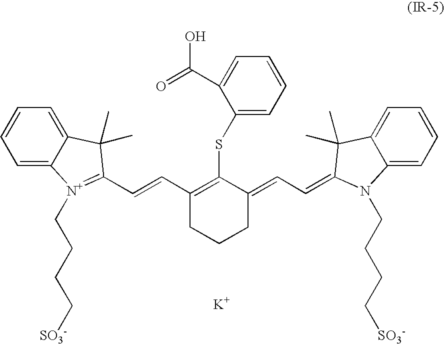

The formation of the lithographic image by the plate precursor of the present invention is due to a heat-induced solubility differential of the coating during processing in the developer. The solubility differentiation between image (printing, oleophilic) and non-image (non-printing, hydrophilic) areas of the lithographic image is characterized by a kinetic rather than a thermodynamic effect, i.e. the non-image areas are characterized by a faster dissolution in the developer that the image-areas. In a most preferred embodiment, the non-image areas of the coating dissolve completely in the developer before the image areas are attacked so that the latter are characterized by sharp edges and high ink-acceptance. The time difference between completion of the dissolution of the non-image areas and the onset of the dissolution of the image areas is preferably longer than 10 seconds, more preferably longer than 20 seconds and most preferably longer than 60 seconds, thereby offering a wide development latitude. The precursor can be positive- or negative-working with the positive-working embodiment being preferred.

The support of the lithographic printing plate precursor has a hydrophilic surface or is provided with a hydrophilic layer. The support may be a sheet-like material such as a plate or it may be a cylindrical element such as a sleeve which can be slid around a print cylinder of a printing press. Preferably, the support is a metal support such as aluminum or stainless steel. The support can also be a laminate comprising an aluminum foil and a plastic layer, e.g. polyester film.

A particularly preferred lithographic support is an electrochemically grained and anodized aluminum support. Graining and anodization of aluminum is well known in the art. The anodized aluminum support may be treated to improve the hydrophilic properties of its surface. For example, the aluminum support may be silicated by treating its surface with a sodium silicate solution at elevated temperature, e.g. 95° C. Alternatively, a phosphate treatment may be applied which involves treating the aluminum oxide surface with a phosphate solution that may further contain an inorganic fluoride. Further, the aluminum oxide surface may be rinsed with a citric acid or citrate solution. This treatment may be carried out at room temperature or may be carried out at a slightly elevated temperature of about 30 to 50° C. A further interesting treatment involves rinsing the aluminum oxide surface with a bicarbonate solution. Still further, the aluminum oxide surface may be treated with polyvinylphosphonic acid, polyvinylmethylphosphonic acid, phosphoric acid esters of polyvinyl alcohol, polyvinylsulfonic acid, polyvinylbenzenesulfonic acid, sulfuric acid esters of polyvinyl alcohol, and acetals of polyvinyl alcohols formed by reaction with a sulfonated aliphatic aldehyde It is further evident that one or more of these post treatments may be carried out alone or in combination. More detailed descriptions of these treatments are given in GB-A-1 084 070, DE-A-4 423 140, DE-A-4 417 907, EP-A-659 909, EP-A-537 633, DE-A-4 001 466, EP-A-292 801, EP-A-291 760 and U.S. Pat. No. 4,458,005.

According to another embodiment, the support can also be a flexible support, which is provided with a hydrophilic layer, hereinafter called ‘base layer’. The flexible support is e.g. paper, plastic film, thin aluminum or a laminate thereof. Preferred examples of plastic film are polyethylene terephthalate film, polyethylene naphthalate film, cellulose acetate film, polystyrene film, polycarbonate film, etc. The plastic film support may be opaque or transparent.

The base layer is preferably a cross-linked hydrophilic layer obtained from a hydrophilic binder cross-linked with a hardening agent such as formaldehyde, glyoxal, polyisocyanate or a hydrolyzed tetra-alkylorthosilicate. The latter is particularly preferred. The thickness of the hydrophilic base layer may vary in the range of 0.2 to 25 μm and is preferably 1 to 10 μm. The hydrophilic binder for use in the base layer is e.g. a hydrophilic (co)polymer such as homopolymers and copolymers of vinyl alcohol, acrylamide, methylol acrylamide, methylol methacrylamide, acrylate acid, methacrylate acid, hydroxyethyl acrylate, hydroxyethyl methacrylate or maleic anhydride/vinylmethylether copolymers. The hydrophilicity of the (co)polymer or (co)polymer mixture used is preferably the same as or higher than the hydrophilicity of polyvinyl acetate hydrolyzed to at least an extent of 60% by weight, preferably 80% by weight. The amount of hardening agent, in particular tetraalkyl orthosilicate, is preferably at least 0.2 parts per part by weight of hydrophilic binder, more preferably between 0.5 and 5 parts by weight, most preferably between 1 parts and 3 parts by weight.

The hydrophilic base layer may also contain substances that increase the mechanical strength and the porosity of the layer. For this purpose colloidal silica may be used. The colloidal silica employed may be in the form of any commercially available water dispersion of colloidal silica for example having an average particle size up to 40 nm, e.g. 20 nm. In addition inert particles of larger size than the colloidal silica may be added e.g. silica prepared according to Stober as described in J. Colloid and Interface Sci., Vol. 26, 1968, pages 62 to 69 or alumina particles or particles having an average diameter of at least 100 nm which are particles of titanium dioxide or other heavy metal oxides. By incorporating these particles the surface of the hydrophilic base layer is given a uniform rough texture consisting of microscopic hills and valleys, which serve as storage places for water in background areas.

Particular examples of suitable hydrophilic base layers for use in accordance with the present invention are disclosed in EP-A-601 240, GB-P-1 419 512, FR-P-2 300 354, U.S. Pat. No. 3,971,660, and U.S. Pat. No. 4,284,705.

The oleophilic layer contains a polymer that is soluble in an aqueous alkaline developer. Any organic, polymeric binder can be used in the present invention. The organic, polymeric binder is preferably a binder having acidic groups with a pKa of less than 13 to ensure that the layer is soluble or at least swellable in aqueous alkaline developers. Advantageously, the binder is a polymer or polycondensate, for example a polyester, polyamide, polyurethane or polyurea. Polycondensates and polymers having free phenolic hydroxyl groups, as obtained, for example, by reacting phenol, resorcinol, a cresol, a xylenol or a trimethylphenol with aldehydes, especially formaldehyde, or ketones are also particularly suitable. Condensates of sulfamoyl- or carbamoyl-substituted aromatics and aldehydes or ketones are also suitable. Polymers of bismethylol-substituted ureas, vinyl ethers, vinyl alcohols, vinyl acetals or vinylamides and polymers of phenylacrylates and copolymers of hydroxylphenylmaleimides are likewise suitable. Furthermore, polymers having units of vinylaromatics, N-aryl(meth)acrylamides or aryl (meth)acrylates may be mentioned, it being possible for each of these units also to have one or more carboxyl groups, phenolic hydroxyl groups, sulfamoyl groups or carbamoyl groups. Specific examples include polymers having units of 2-hydroxyphenyl (meth)acrylate, of N-(4-hydroxyphenyl)(meth)acrylamide, of N-(4-sulfamoylphenyl)-(meth)acrylamide, of N-(4-hydroxy-3,5-dimethylbenzyl)-(meth)acrylamide, or 4-hydroxystyrene or of hydroxyphenylmaleimide. The polymers may additionally contain units of other monomers which have no acidic units. Such units include vinylaromatics, methyl (meth)acrylate, phenyl(meth)acrylate, benzyl (meth)acrylate, methacrylamide or acrylonitrile.

Any amount of binder can be used. The amount of the binder is advantageously from 40 to 99.8% by weight, preferably from 70 to 99.4% by weight, particularly preferably from 80 to 99% by weight, based in each case on the total weight of the nonvolatile components of the coating. In a preferred embodiment, the polycondensate is a phenolic resin, such as a novolac, a resole or a polyvinylphenol. The novolac is preferably a cresol/formaldehyde or a cresol/xylenol/formaldehyde novolac, the amount of novolac advantageously being at least 50% by weight, preferably at least 80% by weight, based in each case on the total weight of all binders.

The dissolution behavior of the oleophilic layer in the developer can be fine-tuned by optional solubility regulating components. More particularly, development accelerators and development inhibitors can be used. These ingredients can be added to the oleophilic layer and/or to (an)other layer(s) of the coating.

Development accelerators are compounds which act as dissolution promoters because they are capable of increasing the dissolution rate of the oleophilic layer. For example, cyclic acid anhydrides, phenols or organic acids can be used in order to improve the aqueous developability. Examples of the cyclic acid anhydride include phthalic anhydride, tetrahydrophthalic anhydride, hexahydrophthalic anhydride, 3,6-endoxy-4-tetrahydro-phthalic anhydride, tetrachlorophthalic anhydride, maleic anhydride, chloromaleic anhydride, alpha-phenylmaleic anhydride, succinic anhydride, and pyromellitic anhydride, as described in U.S. Pat. No. 4,115,128. Examples of the phenols include bisphenol A, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, and 4,4′,3″,4″-tetrahydroxy-3,5,3′,5′-tetramethyltriphenyl-methane, and the like. Examples of the organic acids include sulfonic acids, sulfinic acids, alkylsulfuric acids, phosphonic acids, phosphates, and carboxylic acids, as described in, for example, JP-A Nos. 60-88,942 and 2-96,755. Specific examples of these organic acids include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, 3,4,5-trimethoxybenzoic acid, 2,3,4-trimethoxycinnamic acid, phthalic acid, terephthalic acid, 4-cyclohexene-1,2-dicarboxylic acid, erucic acid, lauric acid, n-undecanoic acid, and ascorbic acid. The amount of the cyclic acid anhydride, phenol, or organic acid contained in the coating is preferably in the range of 0.05 to 20% by weight.

In a preferred embodiment, the coating also contains developer resistance means, also called development inhibitors, i.e. one or more ingredients which are capable of delaying the dissolution of the unexposed areas during processing. The dissolution inhibiting effect is preferably reduced by heating, so that the dissolution of the exposed areas is not delayed and a large dissolution differential between exposed and unexposed areas can thereby be obtained. Such developer resistance means can be added to the oleophilic layer or to another layer of the material.

The compounds described in e.g. EP-A 823 327 and WO97/39894 act as dissolution inhibitors due to interaction, e.g. by hydrogen bridge formation, with the alkali-soluble binder(s) in the coating. Inhibitors of this type typically comprise a hydrogen bridge forming group such as nitrogen atoms, onium groups, carbonyl (—CO—), sulfinyl (—SO—) or sulfonyl (—SO₂—) groups and a large hydrophobic moiety such as one or more aromatic nuclei.

Other suitable inhibitors improve the developer resistance because they delay the penetration of the aqueous alkaline developer into the oleophilic layer. Such compounds can be present in the oleophilic layer itself, as described in e.g. EP-A 950 518, or in a development barrier layer on top of the oleophilic layer, as described in e.g. EP-A 864 420, EP-A 950 517, WO 99/21725 and WO 01/45958. In the positive working embodiment, the barrier layer preferably comprises a polymeric material which is insoluble in or impenetrable by the developer, e.g. acrylic (co-)polymers, polystyrene, styrene-acrylic copolymers, polyesters, polyamides, polyureas, polyurethanes, nitrocellulosics, epoxy resins and silicones. In this embodiment, the solubility of the barrier layer in the developer or the penetrability of the barrier layer by the developer can be reduced by exposure to heat or infrared light.

Preferred examples of inhibitors of the latter type include water-repellent polymers such as a polymer comprising siloxane and/or perfluoroalkyl units. In a typical embodiment, the precursor comprises a barrier layer which contains such a water-repellent polymer in a suitable amount between 0.5 and 25 mg/m², preferably between 0.5 and 15 mg/m² and most preferably between 0.5 and 10 mg/m². Higher or lower amounts are also suitable, depending on the hydrophobic/oleophobic character of the compound. When the water-repellent polymer is also ink-repelling, e.g. in the case of polysiloxanes, higher amounts than 25 mg/m² can result in poor ink-acceptance of the non-exposed areas. An amount lower than 0.5 mg/m² on the other hand may lead to an unsatisfactory development resistance. The polysiloxane may be a linear, cyclic or complex cross-linked polymer or copolymer. The term polysiloxane compound shall include any compound which contains more than one siloxane group —Si(R,R′)—O—, wherein R and R′ are optionally substituted alkyl or aryl groups. Preferred siloxanes are phenylalkylsiloxanes and dialkylsiloxanes. The number of siloxane groups in the (co)polymer is at least 2, preferably at least 10, more preferably at least 20. It may be less than 100, preferably less than 60. In another embodiment, the water-repellant polymer is a block-copolymer or a graft-copolymer of a poly(alkylene oxide) and a polymer comprising siloxane and/or perfluoroalkyl units. A suitable copolymer comprises about 15 to 25 siloxane units and 50 to 70 alkyleneoxide groups. Preferred examples include copolymers comprising phenylmethylsiloxane and/or dimethylsiloxane as well as ethylene oxide and/or propylene oxide, such as Tego Glide 410, Tego Wet 265, Tego Protect 5001 or Silikophen P50/X, all commercially available from Tego Chemie, Essen, Germany. Such a copolymer acts as a surfactant which upon coating, due to its bifunctional structure, tends to position itself at the interface between the coating and air and thereby forms a separate top layer even when applied as an ingredient of the coating solution of the oleophilic layer. Simultaneously, such surfactants act as a spreading agent which improves the coating quality. Alternatively, the water-repellent polymer can be applied in a second solution, coated on top of the oleophilic layer. In that embodiment, it may be advantageous to use a solvent in the second coating solution that is not capable of dissolving the ingredients present in the first layer so that a highly concentrated water-repellent phase is obtained at the top of the material.

To protect the surface of the coating, in particular from mechanical damage, a protective layer may also optionally be applied. The protective layer generally comprises at least one water-soluble polymeric binder, such as polyvinyl alcohol, polyvinylpyrrolidone, partially hydrolyzed polyvinyl acetates, gelatin, carbohydrates or hydroxyethylcellulose, and can be produced in any known manner such as from an aqueous solution or dispersion which may, if required, contain small amounts, i.e. less than 5% by weight, based on the total weight of the coating solvents for the protective layer, of organic solvents. The thickness of the protective layer can suitably be any amount, advantageously up to 5.0 μm, preferably from 0.1 to 3.0 μm, particularly preferably from 0.15 to 1.0 μm.

Optionally, the coating and more specifically the oleophilic layer thereof may further contain additional ingredients. Preferred ingredients are e.g. additional binders, especially sulfonamide and phthalimide groups containing polymers, to improve the run length and chemical resistance of the plate. Examples of such polymers are those described in EP-A 933682, EP-A 894622 and WO 99/63407. Also colorants can be added such as dyes or pigments which provide a visible color to the coating and which remain in the coating at unexposed areas so that a visible image is produced after exposure and processing. Typical examples of such contrast dyes are the amino-substituted tri- or diarylmethane dyes, e.g. Crystal Violet, Methyl Violet, Victoria Pure Blue, Flexoblau 630, Basonylblau 640, auramine and malachite green. Surfactants, especially perfluoro surfactants, silicon or titanium dioxide particles, polymers particles such as matting agents and spacers are also well-known components of lithographic coatings which can be used in the plate precursor of the present invention.

For the preparation of the lithographic plate precursor, any known method can be used. For example, the above ingredients can be dissolved in a solvent mixture which does not react irreversibly with the ingredients and which is preferably tailored to the intended coating method, the layer thickness, the composition of the layer and the drying conditions. Suitable solvents include ketones, such as methyl ethyl ketone (butanone), as well as chlorinated hydrocarbons, such as trichloroethylene or 1,1,1-trichloroethane, alcohols, such as methanol, ethanol or propanol, ethers, such as tetrahydrofuran, glycol-monoalkyl ethers, such as ethylene glycol monoalkyl ether, e.g. 2-methoxy-1-propanol, or propylene glycol monoalkyl ether and esters, such as butyl acetate or propylene glycol monoalkyl ether acetate. It is also possible to use a mixture which, for special purposes, may additionally contain solvents such as acetonitrile, dioxane, dimethylacetamide, dimethylsulfoxide or water.

Any coating method can be used for applying one or more coating solutions to the hydrophilic surface of the support. A multi-layer coating can be applied by coating/drying each layer consecutively or by the simultaneous coating of several coating solutions at once. In the drying step, the volatile solvents are removed from the coating until the coating is self-supporting and dry to the touch. However it is not necessary (and may not even be possible) to remove all the solvent in the drying step. Indeed the residual solvent content may be regarded as an additional composition variable by means of which the composition may be optimized. Drying is typically carried out by blowing hot air onto the coating, typically at a temperature of at least 70° C., suitably 80-150° C. and especially 90-140° C. The drying time may typically be 15-600 seconds.

The material can be image-wise exposed directly with heat, e.g. by means of a thermal head, or indirectly by infrared light, preferably near infrared light. The infrared light is preferably converted into heat by an IR light absorbing compound as discussed above. The heat-sensitive lithographic printing plate precursor of the present invention is preferably not sensitive to visible light, i.e. no substantial effect on the dissolution rate of the coating in the developer is induced by exposure to visible light. Most preferably, the coating is not sensitive to ambient daylight, i.e. visible (400-750 nm) and near UV light (300-400 nm) at an intensity and exposure time corresponding to normal working conditions so that the material can be handled without the need for a safe light environment. “Not sensitive” to daylight shall mean that no substantial change of the dissolution rate of the coating in the developer is induced by exposure to ambient daylight. In a preferred daylight stable embodiment, the coating does not comprise photosensitive ingredients, such as (quinone)diazide or diazo(nium) compounds, photoacids, photoinitiators, sensitizers etc., which absorb the near UV and/or visible light that is present in sun light or office lighting and thereby change the solubility of the coating in exposed areas.

The printing plate precursor of the present invention can be exposed to infrared light by means of e.g. LEDs or a laser. Most preferably, the light used for the exposure is a laser emitting near infrared light having a wavelength in the range from about 750 to about 1500 nm, such as a semiconductor laser diode, a Nd:YAG or a Nd:YLF laser. The required laser power depends on the sensitivity of the image-recording layer, the pixel dwell time of the laser beam, which is determined by the spot diameter (typical value of modern plate-setters at 1/e² of maximum intensity: 10-25 μm), the scan speed and the resolution of the exposure apparatus (i.e. the number of addressable pixels per unit of linear distance, often expressed in dots per inch or dpi; typical value: 1000-4000 dpi).

Two types of laser-exposure apparatuses are commonly used: internal (ITD) and external drum (XTD) plate-setters. ITD plate-setters for thermal plates are typically characterized by a very high scan speed up to 500 m/sec and may require a laser power of several Watts. XTD plate-setters for thermal plates having a typical laser power from about 200 mW to about 1 W operate at a lower scan speed, e.g. from 0.1 to 10 m/sec.

The known plate-setters can be used as an off-press exposure apparatus, which offers the benefit of reduced press down-time. XTD plate-setter configurations can also be used for on-press exposure, offering the benefit of immediate registration in a multi-color press. More technical details of on-press exposure apparatuses are described in e.g. U.S. Pat. No. 5,174,205 and U.S. Pat. No. 5,163,368.

In the development step, the non-image areas of the coating are removed by immersion in a conventional aqueous alkaline developer, which may be combined with mechanical rubbing, e.g. by a rotating brush. During development, any water-soluble protective layer present is also removed. Silicate-based developers which have a ratio of silicon dioxide to alkali metal oxide of at least 1 are preferred to ensure that the alumina layer (if present) of the substrate is not damaged. Preferred alkali metal oxides include Na₂O and K₂O, and mixtures thereof. In addition to alkali metal silicates, the developer may optionally contain further components, such as buffer substances, complexing agents, antifoams, organic solvents in small amounts, corrosion inhibitors, dyes, surfactants and/or hydrotropic agents as well known in the art. The development is preferably carried out at temperatures of from 20 to 40° C. in automated processing units as customary in the art. For regeneration, alkali metal silicate solutions having alkali metal contents of from 0.6 to 2.0 mol/l can suitably be used. These solutions may have the same silica/alkali metal oxide ratio as the developer (generally, however, it is lower) and likewise optionally contain further additives. The required amounts of regenerated material must be tailored to the developing apparatuses used, daily plate throughputs, image areas, etc. and are in general from 1 to 50 ml per square meter of recording material. The addition can be regulated, for example, by measuring the conductivity as described in EP-A 0 556 690.

The plate precursor according to the invention can, if required, then be post-treated with a suitable correcting agent or preservative as known in the art. To increase the resistance of the finished printing plate and hence to extend the print run, the layer can be briefly heated to elevated temperatures (“baking”). As a result, the resistance of the printing plate to washout agents, correction agents and UV-curable printing inks also increases. Such a thermal post-treatment is described, inter alia, in DE-A 14 47 963 and GB-A 1 154 749.

Besides the mentioned post-treatment, the processing of the plate precursor may also comprise a rinsing step, a drying step and/or a gumming step.

The printing plate thus obtained can be used for conventional, so-called wet offset printing, in which ink and an aqueous dampening liquid is supplied to the plate. Another suitable printing method uses so-called single-fluid ink without a dampening liquid. Single-fluid inks which are suitable for use in the method of the present invention have been described in U.S. Pat. No. 4,045,232; U.S. Pat. No. 4,981,517 and U.S. Pat. No. 6,140,392. In a most preferred embodiment, the single-fluid ink comprises an ink phase, also called the hydrophobic or oleophilic phase, and a polyol phase as described in WO 00/32705.

### EXAMPLES

Solubility of the IR-Dyes

The solubility of the IR-dyes IR-1 to −5 and of a comparison dye Cl (commercially available from FEW Chemicals GmbH) was determined as follows:

the extinction coefficient of the dyes was measured in methanol with a HP8453 UV/VIS/NIR spectrophotometer;

a supersaturated solution of the dyes in a) 2-methoxyl-propanol (MOP) and b) water/NaOH (pH=9) was prepared; after filtration the concentration of dissolved dye was determined by dissolution with methanol using the previous determined extinction coefficient.

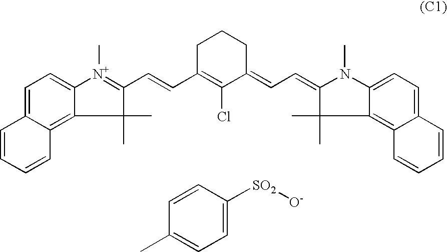

TABLE 1
Solubility of the IR-dyes

| | Solubility | | Solubility in | |
|---|---|---|---|---|
| Dye | in MOP | | H₂O/NaOH at pH = 9 | |
| IR-dye 1 | 3.8 | g/l | 40.1 | g/l |
| IR-dye 2 | 0.42 | g/l | >50 | g/l |
| IR-dye 3 | >100 | g/l | >50 | g/l |
| IR-dye 4 | 5.7 | g/l | >50 | g/l |
| IR-dye 5 | 91.3 | g/l * | >50 | g/l |
| Comparison | 50.1 | g/l | <2 | mg/l ** |

* tri-ethylamine was added to dissolve the dye
** insoluble at pH = 9; NaOH was added until pH = 11.7

Preparation of the Support

A 0.30 mm thick aluminum foil was degreased by immersing the foil in an aqueous solution containing 5 g/l of sodium hydroxide at 50° C. and rinsed with demineralized water. The foil was then electrochemically grained using an alternating current in an aqueous solution containing 4 g/l of hydrochloric acid, 4 g/l of hydroboric acid and 5 g/l of aluminum ions at a temperature of 35° C. and a current density of 1200 A/m² to form a surface topography with an average center-line roughness Ra of 0.5 μm.

After rinsing with demineralized water the aluminum foil was then etched with an aqueous solution containing 300 g/l of sulfuric acid at 60° C. for 180 seconds and rinsed with demineralized water at 25° C. for 30 seconds.

The foil was subsequently subjected to anodic oxidation in an aqueous solution containing 200 g/l of sulfuric acid at a temperature of 45° C., a voltage of about 10 V and a current density of 150 A/m² for about 300 seconds to form an anodic oxidation film of 3.00 g/m² of Al₂O₃ then washed with demineralized water, post-treated with a solution containing polyvinylphosphonic acid and subsequently with a solution containing aluminum trichloride, rinsed with demineralized water at 20° C. during 120 seconds and dried.

Test of Inhibiting Capability of the Dyes

A layer of novolac (Alnovol SPN452 from Clariant, a 40.5 wt. % solution in methoxypropanol) and the dyes specified in Table 2 were coated on the above support. After drying during 1 min at 130° C., the samples contained 0.9 g/m² of novolac. A series of unexposed samples is immersed in Agfa EP26 developer at 20° C., each sample during a different time period. After the immersion period, the sample was removed from the developer, immediately rinsed with water, dried and then the dissolution of the coating in the developer was measured by comparing the weight of the sample before and after the development. As soon as the coating is dissolved completely, no more weight loss is measured upon longer immersion time periods, i.e. a curve representing weight loss as a function of immersion time reaches a plateau from the moment of complete dissolution of the layer, which is referred to herein as “dissolution time”. When the dissolution time of the sample containing the IR dye is longer than the dissolution time of the sample without the IR dye, then the IR dye clearly acts as an inhibitor. When the dissolution time of the sample containing the IR dye is not longer than the value of the reference sample, then the IR dye is non-inhibiting and, as a result, does not reduce the solubility of the oleophilic layer in the developer.

TABLE 2

| | | | Dissolution |
|---|---|---|---|
| Example no. | Dye (mg/m²) | | time (sec) |
| 1 (ref.) | none | | 30 |
| 2 (inv.) | IR-1 | (35) | 30 |
| 3 (inv.) | IR-2 | (35) | 20 |
| 4 (inv.) | IR-3 | (35) | 30 |
| 5 (inv.) | IR-4 | (35) | 20 |
| 6 (inv.) | IR-5 | (35) | 25 |
| 7 (comp.) | Cl | (35) | 60 |

Examples 2-6 contained a dye according to the invention and showed equal or shorter dissolution time values than reference Example 1 without dye. Comparative Example 7 showed a longer dissolution time than the materials according to the invention.

Plate Precursor Materials

The solutions in Table 3 below were coated on the above support at a wet coating thickness of 22 μm on a coating line at a speed of 10.8 m/min using drying temperatures of 135° C. The materials were then imaged on a Creo Trendsetter 3244 (830 nm) using different energy density settings (intensity at the image plane) in the range from 90 mJ/cm² up to 220 mJ/cm². The plates were then processed in an Agfa Autolith PN85 processor operating at a speed of 0.96 m/min using Agfa DP300 developer at 25° C. and finally gummed with Agfa Ozasol RC795. The IR-sensitivity of the different compositions corresponds to the minimum energy density setting that is required to obtain a 50% reduction of the light absorption of the coating, measured on the developed plate at the wavelength maximum of the contrast dye, in areas which have been exposed with a dot area of a 50% screen (@200 lpi).

The results in Table 3 indicate that the non-inhibiting dyes IR-1 to −5 provide a higher sensitivity than the inhibiting IR-dye C1.

TABLE 3

| | Ex. 8 | Ex. 9 | Ex. 10 | Ex. 11 | Ex. 12 | Ex. 13 |
|---|---|---|---|---|---|---|
| Ingredients (g) | (inv.) | (inv.) | (inv.) | (inv.) | (inv.) | (comp.) |
| Tetrahydrofuran | 206 | 206 | 206 | 206 | 206 | 206 |
| Alvonol SPN452* | 131 | 131 | 131 | 131 | 131 | 131 |
| Methoxypropanol | 241 | 241 | 241 | 241 | 241 | 241 |
| Methyl ethyl ketone | 263 | 263 | 263 | 263 | 263 | 263 |
| C1 | — | — | — | — | — | 1.77 |
| IR-1 | 1.77 | — | — | — | — | — |
| IR-2 | — | 1.77 | — | — | — | — |
| IR-3 | — | — | 1.77 | — | — | — |
| IR-4 | — | — | — | 1.77 | — | — |
| IR-5 | — | — | — | — | 1.77 | — |
| contrast dye** | 120 | 120 | 120 | 120 | 120 | 120 |
| Tego Glide 410*** | 25.25 | 25.25 | 25.25 | 25.25 | 25.25 | 25.25 |
| 2,3,4-trimethoxy-cinnamic acid | 4.55 | 4.55 | 4.55 | 4.55 | 4.55 | 4.55 |
| IR sensitivity (mJ/cm²) | 115 | 115 | 115 | 115 | 115 | 190 |

*Alvonol SPN452 is a 40.5% solution in Dowanol PM (commercially available from Clariant)
**1% w/w solution in methoxypropanol of the following non-inhibiting dye:

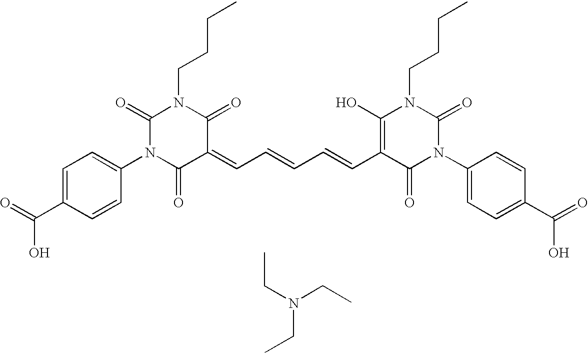

***Surfactant commercially available from Tego Chemie, Essen,
Germany; 1 wt. % solution in methoxypropanol.

We claim:

1. A heat-sensitive lithographic printing plate precursor comprising (i) a support having a hydrophilic surface or which is provided with a hydrophilic layer and (ii) a coating provided thereon, the coating comprising (a) an oleophilic layer which comprises a polymer that is soluble in an aqueous alkaline developer and (b) an infrared light absorbing compound according to the following formula: 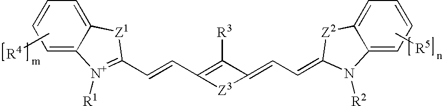
wherein
m and n each independently represent an integer from 0 to 4;
Z¹ and Z² each independently represent one or two non-metallic atoms, which may be substituted, necessary to complete a 5- or 6-membered heterocyclic ring;
Z³ represents two or three non-metallic atoms, which may be substituted, necessary to complete a 5- or 6-membered heterocyclic or carbocyclic ring;
each R¹, R², R⁴ and R⁵ independently represent an optionally substituted alkyl, alkenyl, aryl or aralkyl group, or a group selected from -G¹, -L¹-G¹, —CN, a halogen, —NO₂, —ORₐ, —CO—Rₐ, —CO—O—Rₐ, —O—CO—R_{d}, —CO—NR_{d}Rₑ, —NR_{d}Rₑ, —NR_{d}—CO—Rₑ, —NR_{d}—CO—O—Rₐ, —NR_{d}—CO—NRₑR_{f}, —SR_{d}, —SO—Rₐ, —SO₂—Rₐ, —SO₂—O—Rₐ and —SO₂—NRₐR_{b}; or wherein two adjacent R⁴ and R⁵ groups together form an optionally substituted 5- or 6 membered ring which is fused to the ring formed by Z¹ or Z²;
R³ represents a hydrogen or a halogen atom, -L₂-G², an alkyl group, an alkenyl group, an aralkyl group, an aryl group, a thioalkyl group or a thioaryl group, each of said groups being optionally substituted;
with
L₁ and L₂ being a divalent linking group;
Rₐ, R_{b} and R_{c} being an optionally substituted alkyl, alkenyl, aryl or aralkyl group;
R_{d}, Rₑ, and R_{f} being hydrogen or an optionally substituted alkyl, alkenyl, aryl or aralkyl group;
wherein the solubilizing groups G¹ and G² are anionic or become anionic in an aqueous alkaline solution having a pH of at least 9 and wherein the total number of the solubilizing groups G¹ and G² is equal to three, four or five.

2. A printing plate precursor according to claim 1 wherein R³ comprises at least one of said solubilizing groups.

3. A printing plate precursor according to claim 1 wherein R¹, R², R³, R⁴ and R⁵ each comprise one of said solubilizing groups.

4. A printing plate precursor according to claim 1 wherein the IR light absorbing compound comprises three solubilizing groups, of which one is comprised in each of R¹, R² and R³.

5. A printing plate precursor according to claim 1 wherein the IR light absorbing compound comprises three solubilizing groups, of which one is comprised in each of R³, R⁴ and R⁵.

6. A printing plate precursor according to claim 1 wherein the IR light absorbing compound comprises four solubilizing groups, of which one is comprised in each of R¹, R², R⁴ and R⁵.

7. A printing plate precursor according to claim 1 wherein Z¹ and Z² are —C(CH₃)₂.

8. A printing plate precursor according to claim 1 wherein Z³ is (CH₂)₂— or —(CH₂)₃.

9. A printing plate precursor according to claim 1 wherein R³ is —Cl or optionally substituted —S—C₆H₅.

10. A printing plate precursor according to claim 1 wherein the solubilizing group is a carboxy group, a sulfo group or a hydroxy group, or salts thereof.
